(19) United States
(12) Patent Application Publication
(10) Pub. No.: US 2024/0380841 A1
(43) Pub. Date: Nov. 14, 2024

(54) DETECTION AND ALERT LOGIC BY CLOUD DATA FOR A POTENTIAL HARMFUL OR DISLIKE NUMBER

(71) Applicant: T-Mobile USA, Inc., Bellevue, WA (US)

(72) Inventors: Do Kyu Lee, Mercer Island, WA (US); Antoine T. Tran, Bellevue, WA (US)

(21) Appl. No.: 18/195,302

(22) Filed: May 9, 2023

(51) Int. Cl. H04M 3/436

(52) U.S. Cl. CPC H04M 3/436

(57) ABSTRACT

Methods and systems for improving the detection and alert logic by cloud data for a potential harmful or dislike number are described herein. According to an implementation, a computer server, e.g., a telephony application server (TAS), may receive a voice call associated with a phone number to a user. The TAS may determine that the phone number is associated with a category of a potential harmful number or a potential dislike number. The TAS may generate a string indicative of the category and present the string on a user interface of the user device. The TAS may apply a machine learning model to classify an incoming call. The machine learning model may be trained based on one or more voice data metrics such as call duration, call rejection rate, etc. The training may be further supplemented by personal data on the user device to provide accurate classification.

### BACKGROUND

In current telecommunication network, when an end user receives a voice call, authentication is applied on the originating phone dialer by a telephony application server (TAS). If the originating phone dialer appears to be a scam, the incoming call may be displayed as “scam likely” or “unknown caller” on a graphical user interface (GUI) of the end user device. The current scam detection logic is based on the voice call session information from IP multimedia subsystem (IMS) related attributes via TAS. However, a Robo call can be seen with a phone number by manipulation from the call originator party. For example, a mobile originator (MO) may intentionally use hacking information or roaming different call characteristics or landline attributes that do not match the authentication logic of TAS and the mobile terminator (MT). It is challenging for the end user to determine whether the incoming call is from a potential harmful or dislike number.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which detection and alert logic by cloud data for a potential harmful or dislike number are implemented, according to an example of the present disclosure.

FIG. 2 illustrates another example network scenario, in which detection and alert logic by cloud data for a potential harmful or dislike number are implemented, according to an example of the present disclosure.

FIG. 3 illustrates an example diagram for detecting and alerting a voice call from a potential harmful or dislike number, according to another example of the present disclosure.

FIG. 4 illustrates an example diagram for training a classifier for detecting and alerting a voice call from a potential harmful or dislike number, according to an example of the present disclosure.

FIG. 5A illustrates an example flowchart for training a classifier for detecting and alerting a voice call from a potential harmful or dislike number, according to an example of the present disclosure.

FIG. 5B illustrates another example flowchart for training a classifier for detecting and alerting a voice call from a potential harmful or dislike number, according to an example of the present disclosure.

FIG. 6 illustrates an example flowchart for detecting and alerting a voice call from a potential harmful or dislike number, according to an example of the present disclosure.

FIG. 7 illustrates an example computer server, in which detection and alert logic by cloud data for a potential harmful or dislike number are implemented, according to an example of the present disclosure.

### DETAILED DESCRIPTION

Techniques for detecting a voice call from a potential harmful number (PHN) or a potential dislike number (PDN) and alerting an end user by presenting an illustrative string on a user interface (UI) of a user equipment (UE) of the end user, are disclosed herein.

In implementations, a computer server in a telecommunication network may receive a voice call originated from a phone number to an end user. The computer server may apply a machine learning model trained to determine whether the phone number is associated with a potential harmful number or a potential dislike number. When the phone number falls into one of the categories, e.g., the PDN or the PHN, the computer server may generate a string corresponding to the category and present the string on a user interface (UI) of the end user's device. The computer server may be a telephony application server (TAS).

In implementations, the machine learning model may be a PDN/PHN classifier trained by a server device, e.g., the TAS and/or another computer server located in a cloud environment. The server device may obtain, from a database, the historical data associated with voice calls originated from a target phone number. The server device may extract one or more metrics associated with the voice calls and build a training data set based on the one or more metrics.

As discussed herein, the one or more metrics associated with the voice calls may be applied to identify the patterns of a potential harmful call or a potential disliked call. Examples of the one or more metrics may include but are not limited to call durations, call rejection rate, call no-answering rate, similarity of the area code of the incoming call with the area code of the recipient's phone number (e.g., whether the caller is mimicking a friend or a family member of the callee), call date and time, etc.

In implementations, the server device may generate one or more machine learning models or filters with respect to each of the one or more metrics. The server device may select different machine learning models and/or algorithms for different metrics. Taken the training data indicative of each individual metric as an input, a corresponding machine learning model may output a probability that indicates a likelihood of the incoming call being associated with either a PDN or a PHN. For example, a first machine learning model may output a first probability of the incoming call being associated with a PDN, predicted based on the call durations. In another example, a second machine learning model may output a second probability of the incoming call being associated with a PHN, predicted based on the call rejection rates across all the call recipients. The server device may aggregate the outputs from all the machine learning models and generate an overall prediction as to whether the incoming call is associated with a PDN or a PHN. In some examples, the server device may apply any ensemble algorithms to combine the multiple outputs and generate the overall prediction.

In some examples, the server device may supplement the training with personal data from the recipient's device to achieve more accurate classification of an incoming call. For example, the call recipient may not answer the incoming call when he/she is in a conference or in travel. Supplementing the personal data such as calendar events may provide additional interpretation why the incoming call was not answered. In implementations, the server device may send, in advance, an agreement on sharing the personal data to the recipient's device. The agreement may be sent in text, email, or presented as an instant message on the user interface of the recipient's device. Once the call recipient consents on the agreement, the personal data will be made available to the server device. The server device may generate additional machine learning models based on the supplemented data and consider the output of the additional machine learning models to determine whether the incoming call is associated with a PDN or a PHN.

Additionally or alternatively, the server device may collect the feedbacks from the call recipients with respect to the short-duration calls, rejected calls, or not answered calls. For example, the user device of the call recipient experiencing poor connection may cause missing of the incoming call or short duration of the call. The server device may further supplement the information from the feedbacks to the training to provide more accurate prediction on the category of the incoming call.

In implementations, the server device may generate one or more strings corresponding to each category and provide at least one string to the call recipient. The at least one string may be presented together with the phone number on the UI of the call recipient's device. In some examples, the string may be a text string that provides descriptions, patterns, or observations associated with the caller phone number. An example of the string may be “the calls from the phone number were disconnected in 5 seconds for most users.” Another example of the string may be “95% of the users among all the callees rejected the phone number in the past month.”

The present disclosure supplements the authentication, detection, and/or alert logic of current TAS and generates specific information in a UI string with respect to the caller number's classification, thus, assisting the end user to determine whether an incoming call needs to be answered.

The techniques discussed herein may be implemented in a computer network using one or more of protocols including but are not limited to Ethernet, 3G, 4G, 4G/LTE, 5G, 6G, the further radio access technologies, or any combination thereof. In some examples, the network implementations may support standalone architectures, non-standalone architectures, dual connectivity, carrier aggregation, etc. Example implementations are provided below with reference to the following figures.

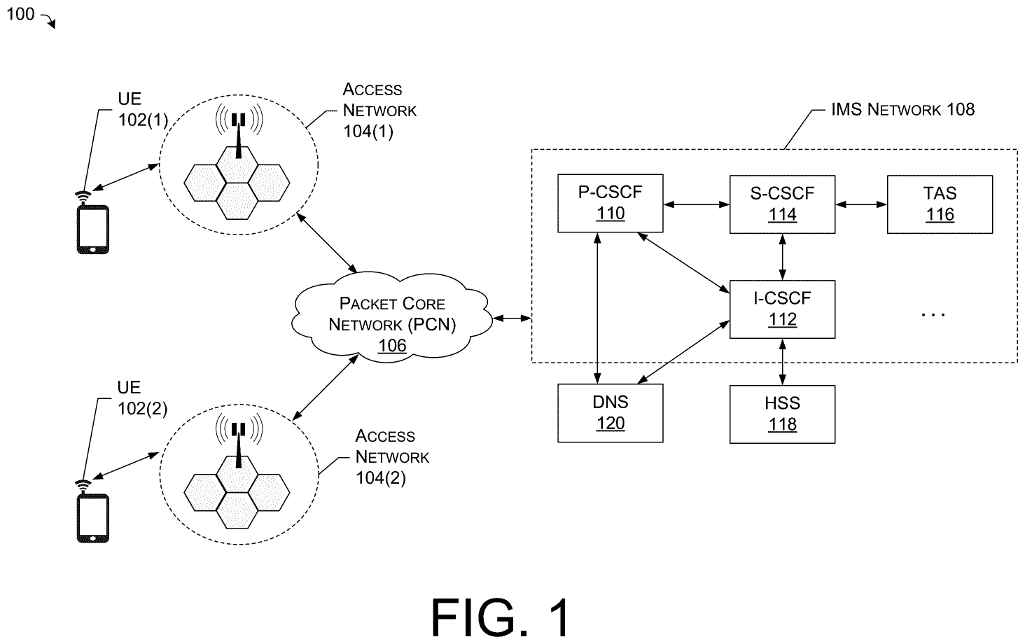

FIG. 1 illustrates an example network scenario, in which detection and alert logic by cloud data for a potential harmful or dislike number are implemented, according to an example of the present disclosure.

The network scenario 100, as illustrated in FIG. 1 may be part of a telecommunication network of a wireless service provider such as, T-Mobile, AT&T, Verizon Wireless, etc. The telecommunication network may include one or more packet core networks, one or more IP multimedia subsystems (IMSs), and one or more access networks through which, user equipment can connect to the one or more packet core networks and the IMSs. The packet core network, for example, PCN 106, may be a 4G evolved packet core (EPC) network or a 5G core network. The one or more access networks, for example, access network 104(1) and access network 104(2), may be compatible with one or more radio access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology.

The access networks 104(1) and 104(2) may include various types of base stations, for example, 2G base stations and/or 3G NodeBs that are associated with GSM and CDMA access network, eNBs that are associated with an LTE access network known as an Evolved UMTS Terrestrial Radio Access Network (E-UTRAN), or gNBs or as new radio (NR) base stations that are associated with a 5G access network.

The IMS network, for example, IMS network 108, may include multiple components that function together to deliver multimedia communications services such as voice, video and text messaging over the IP network, e.g., PCN 106. For example, the IMS network 108 may include a proxy call session control function (P-CSCF) 110, an interrogating call session control function (I-CSCF) 112, a serving call session control function (S-CSCF) 114, a telephony application server (TAS) 116, etc.

As discussed herein, a user equipment may need to be registered on the IMS network in order to use the IP multimedia service. As shown in FIG. 1, the UE 102(1) may connect to the PCN 106 through the access network 104(1) and further register on the IMS network 108; while the UE 102(2) may connect to the PCN 106 through the access network 104(2) and further register on the IMS network 108. During the registration process, the I-CSCF 112 may send a user authentication request (UAR) to a home subscriber server (HSS) 118 to authenticate a user equipment, e.g., UE 102(1) or UE 102(2). The HSS 118 may return a user authentication answer (UAA) that indicates whether the UAR is approved. In some examples, the P-CSCF 110 may query a domain name server (DNS) 120 to discover a fully qualified domain name (FQDN) or the IP address of the I-CSCF 112 to forward the registration request from the UE. The I-CSCF 112 may also query the DNS 120 to obtain the FQDN or the IP address of the S-CSCF 114 to forward the registration request to complete the registration of the UE.

Once the UE is registered on the IMS network, the UE can use the services provided through a plurality of application servers on the IMS network. The TAS 116 in the IMS network, for example, may provide basic call processing services and supplementary multimedia services between the users such as call setup, call waiting, call forwarding, caller ID service, origination-denial, termination-denial, lettering and coloring, etc. For example, when the UE 102(1) originates a voice call to the UE 102(2), the TAS 116 may check a national caller ID/name database to identify a phone number/name associated with the voice call. The TAS 116 may then notify the recipient, i.e., UE 102(2), about who is calling. In some examples, when the caller is in the contact list of the recipient, a caller name may be presented on a user interface (UI) of the UE 102(2). In another example, when the caller is a registered business entity, a description/name of the business entity may be presented on the UI of the UE 102(2). In yet some other examples, when the caller can be found in the national caller ID/name database but is not in the contact list of the recipient, a string of “Maybe John Brown” is displayed along with the phone number. Alternatively, a string of “The number being identified as international human” is displayed along with the phone number if there was no agreement to share such information from the user. In yet some other examples, when the caller ID/name cannot be verified, a string of “unknown” or “unknown caller” may be presented on the UI of the UE 102(2).

As discussed herein, the current detection and alert logic of the TAS 116 relies on the subscriber registry information from various carriers in the country. The TAS 116 may also maintain a blacklist or a quarantine list of phone numbers that were previously determined as spam callers. When the TAS 116 detects that an incoming call is associated with a phone number in the blacklist, an alert of “Likely spam” or a similar description may be presented on the UI of the recipient's device. However, some Robo callers may use hacked information related to the mobile call originators and/or the landline attributes that would evade the current detection logic of the TAS 116. Thus, a Robo call may be seen by the call recipient with a phone number, which tricks the call recipient to answer the call.

To address the deficiency of the current detection and alert logic, the present disclosure utilizes the voice call data constantly saved to a cloud datastore to identify the patterns of such Robo calls. A method according to the present disclosure may analyze the mobile terminating (MT) calls that were not answered and/or lasted no more than 5 seconds. In another example, the method according to the present disclosure may analyze the MT calls that were rejected about 90% of the call counts. In yet another example, the method according to the present disclosure may further analyze whether the mobile originating (MO) callers were mimicking friends and families of the MT callees. For example, the phone number of the MO callers may have the same location code, the same mobile county code (MCC), or the same mobile network (MNC) code. In yet another example, the method according to the present disclosure may identify unusual call patterns based on the caller ID of the MO callers. For example, if the MO callers issue massive calls to MT parties within a short period, the MO callers may be flagged as a possible scam call.

In yet another example, the method according to the present disclosure may further utilize personal data on the recipient's device and backed up to the cloud datastore to determine whether a rejection or no-answering of an incoming call is due to a conflict with the recipient's personal and/or business schedule. In implementations, a user agreement to share the personal data may be obtained in advance. The present disclosure may train a machine learning model using the data in the cloud datastore to learn the patterns of the Robo calls. Based on the learned patterns of the Robo calls, the present disclosure may classify those calls to one or more categories and create a string corresponding to each category. In some examples, the string may be a text string that describes a feature of the category, which is presented along with the phone number on the UI of the recipient's device. Examples of the string may include but are not limited to, “Most people did not accept this number,” “This number was disconnected in 5 seconds from other customers in many times nowadays,” etc.

In yet another example, the method according to the present disclosure may add the phone numbers of the Robo calls to the blacklist or the quarantine list maintained by the TAS 116 and/or another network server. The network server may have a webpage accessible to the users that facilitates a call recipient to look up the incoming call phone number and determine whether it is a potential harmful number and/or a potential dislike number. In some examples, the quarantine list may further protect the network side by blacklisting any candidate numbers that are potentially harmful or disliked.

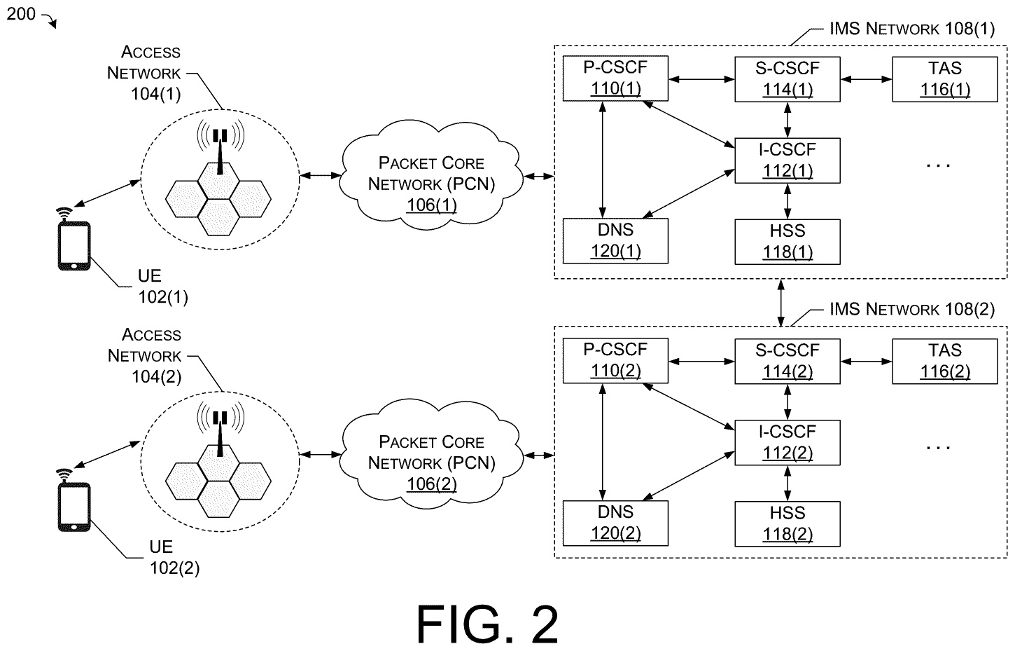

It should be understood that the network scenario shown in FIG. 1 is for the purpose of illustration. A telecommunication network or one or more subsystems of the telecommunication network can be logically divided into a number of regions. Each of the regions may logically include a packet core network and an IMS network. FIG. 2 illustrates another example network scenario 200, in which detection and alert logic by cloud data for a potential harmful or dislike number are implemented, according to an example of the present disclosure. As shown in FIG. 2, the UE 102(1) may connect to the PCN 106(1) and access the IMS network 108(1) and the UE 102(2) may connect to the PCN 106(2) and access the IMS network 108(2). Each of the IMS network 108(1) and 108(2) may maintain an instance of the domain name server, e.g., DNS 120(1) in IMS network 108(1) and DNS 120(2) in IMS network 108(2), an instance of the home subscriber server, e.g., HSS 118(1) in IMS network 108(1) and HSS 118(2) in IMS network 108(2), and an instance of the telephony application server, e.g., the TAS 116(1) in IMS network 108(1) and the TAS 116(2) in IMS network 108(2). In some examples, however, each of the domain name server, the home subscriber server, and the telephony application server may be configured as a centralized component of the telecommunication network accessible to all logically divided IMS networks. Further, although the IMS network as shown in FIG. 1 and FIG. 2 includes a single P-CSCF, a single S-CSCF, and a single I-CSCF, the IMS network can include two or more P-CSCFs, S-CSCFs, and I-CSCFs.

The techniques discussed herein may be implemented in the telecommunication network using one or more of protocols including but are not limited to Ethernet, 3G, 4G, 4G LTE, 5G, or any combination thereof. The techniques may be implemented in the telecommunication network using 6G and/or future radio access technologies.

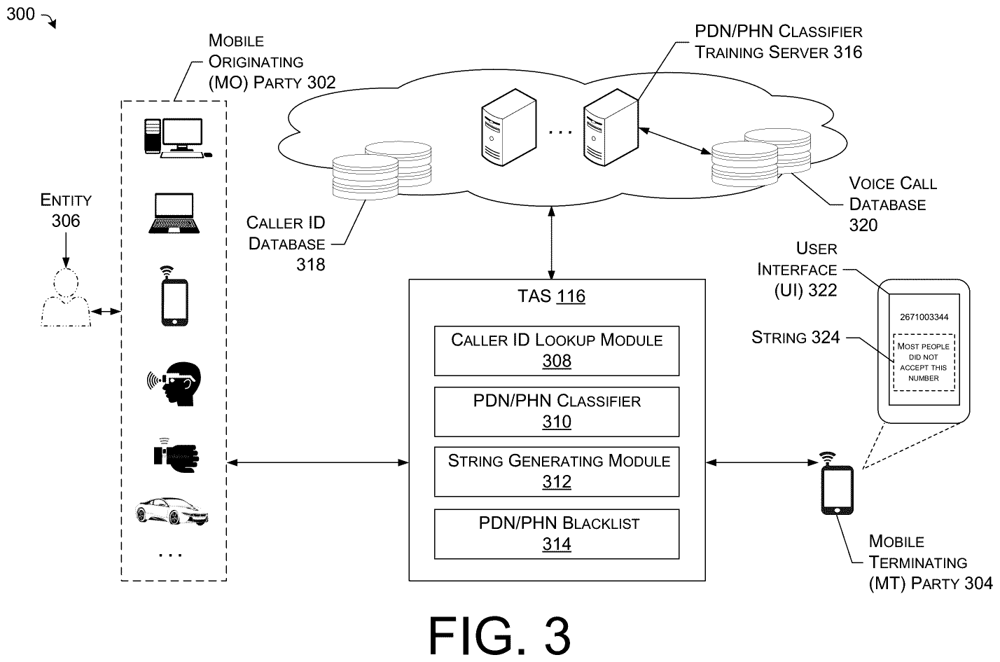

FIG. 3 illustrates an example diagram for detecting and alerting a voice call from a potential harmful or dislike number, according to another example of the present disclosure.

As illustrated in diagram 300, a mobile originating (MO) party 302 may initiate a voice call to a mobile terminating (MT) party 304. The request to establish a call session may be detected by the TAS 116. The TAS 116 may determine whether the MO party 302 is associated with a potential harmful number or a potential dislike number. If the MO party 302 is associated with a potential harmful number or a potential dislike number, the TAS 116 may generate a string 324 to notify the MT party 304. The string 324 may be presented on a user interface (UI) 322 of the MT party 304.

The MO party 302 may be any device that can wirelessly connect to a telecommunication network. In some examples, the MO party 302 may be a mobile phone, such as a smart phone or other cellular phone. In other examples, the MO party 302 may be a personal digital assistant (PDA), a media player, a tablet computer, a gaming device, a smart watch, a hotspot, a personal computer (PC) such as a laptop, desktop, or workstation, or any other type of computing or communication device. In yet other examples, the MO party 302 may include the computing devices implemented on the vehicle including but are not limited to, an autonomous vehicle, a self-driving vehicle, or a traditional vehicle capable of connecting to internet. In yet other examples, the MO party 302 may be a wearable device and/or wearable materials, such as a smart watch, smart glasses, clothes made of smart fabric, etc.

For a Robo call scenario, the MO party 302 may be operated by and/or communicated with an entity 306 (shown in phantom). The entity 306 may include systems, devices, software, apps, users, and/or other features associated with the MO party 302. The entity 306 may operate the MO party 302 to initiate a voice call to the MT party 304. In some examples, the entity 306 may operate the MO party 302 to initiate a voice call to multiple MT parties. Once the Robo call is answered, an automated or pre-recorded voice message may be played to the MT parties.

In some examples, the MO party 302 may be a routed call through another telecommunication operator network.

The TAS 116 may include a caller ID lookup module 308, a potential dislike number (PDN)/potential harmful number (PHN) classifier 310, a string generating module 312, and a PDN/PHN blacklist 314.

The caller ID lookup module 308 may be configured to communicate with a caller ID database 318 located remotely in a network and/or a cloud environment. The caller ID lookup module 308 may periodically dip into the caller ID database 318 to receive the latest updates. The caller ID database 318 may be a national caller ID database that stores the subscriber's information from various carriers.

The PDN/PHN classifier 310 may include one or more machine learning models (e.g., ML model #1, ML model #2, . . . ML model #N) trained to classify a candidate Robo call to one or more categories. For example, the Robo call may be associated with a potential harmful number, a potential dislike number, etc. Each of the ML models may be built and trained with respect to to one of the voice data metrics 402. In some examples, the PDN/PHN classifier 310 may be trained in a remote PDN/PHN classifier training server 316. The PDN/PHN classifier training server 316 may create a training data set based at least in part on the data in the voice call database 320. Each data point of the training data set may represent one or more features related to the MT calls originated from a same phone number. After the PDN/PHN classifier 310 is trained and validated to satisfy a criteria, e.g., the classification accuracy satisfying a threshold, the PDN/PHN classifier 310 may be downloaded and implemented on the PDN/PHN classifier 310 of the TAS 116. In some examples, the PDN/PHN classifier 310 may be trained locally at the TAS 116.

The string generating module 312 may generate one or more strings corresponding to the one or more categories outputted by the PDN/PHN classifier 310. The one or more strings may provide a textual description of the one or more categories. For a potential harmful number, for example, the string generating module 312 may generate a string of “most people did not accept this number.” Alternatively, the string generating module 312 may generate a string of “many people reported spam for this number” for a potential harmful number. For a potential dislike number, the string generating module 312 may generate a string of “this number was call disconnected in 5 seconds from other users many times,” or a string of “this number was rejected by 90% of other users in the past few months,” etc. The string generating module 312 may store the correlation of the one or more categories, e.g., PDN/PHN, with the strings in a datastore of the TAS 116.

The PDN/PHN blacklist 314 may maintain a blacklist of candidate PDNs and PHNs. In some examples, the PDN/PHN blacklist 314 may also include the strings corresponding to the candidate PDNs and PHNs. When an incoming call is determined to be in the blacklist, the TAS 116 may select one of the strings corresponding to the incoming call number and transmit the selected string to the MT party 304.

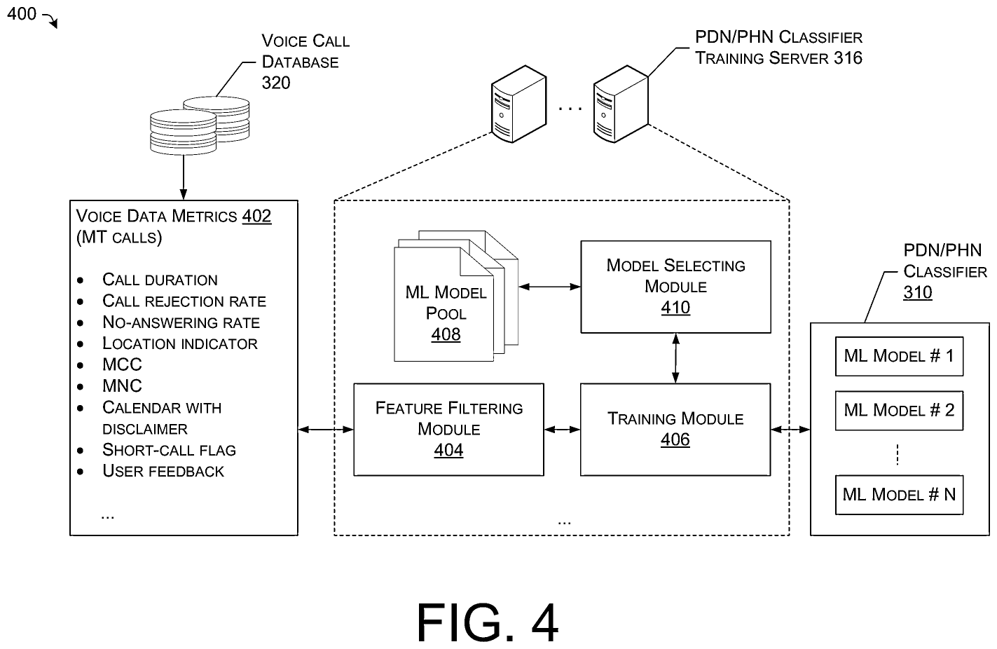

FIG. 4 illustrates an example diagram for training a classifier for detecting and alerting a voice call from a potential harmful or dislike number, according to an example of the present disclosure.

According to diagram 400, the PDN/PHN classifier training server 316 may include a feature filtering module 404, a training module 406, and a model selecting module 410.

The feature filtering module 402 may obtain data from the voice call database 320 and extract a plurality of voice data metrics related to a plurality of MT calls. The plurality of voice data metrics may include but are not limited to a call duration, a call rejection rate, a call no-answering rate, location indicator (e.g., same city or state), mobile county code (MCC), mobile network code (MNC), etc. These voice data metrics may represent the patterns of potential Robo calls. In some examples, the feature filtering module 40 may select the data items in the voice call database 320 that are associated with the plurality of voice data metrics as the training data. One voice data metric may indicate a call duration less than 5 seconds. Another voice data metric may indicate a call rejection rate of all call counts with respect to a particular phone number is equal to or greater than 90%. Yet another voice data metric may indicate that one or more originating phone numbers have the same area code, e.g., MCC or MNC. The feature filtering module 402 may transmit the training data set to the training module 406.

The model selecting module 410 may be configured to select one or more machine learning models from the ML model pool 408. The ML model pool 408 may include a variety of machine learning models such as multilayer perceptrons (MLPs), neural networks (NNs), gradient-boosted NNs, deep neural networks (DNNs) (i.e., neural networks having at least one hidden layer between an input layer and an output layer), recurrent neural networks (RNNs), long short-term memory (LSTM) networks, gated recurrent unit (GRU) networks, decision trees, classification and regression trees (CART), boosted trees or tree ensembles, decision forests, random forest pattern detection, Bayesian networks, support vector machines (SVMs), or hidden Markov models (HMMs), etc. The model selecting module 410 may additionally or alternatively include regression models, e.g., linear or nonlinear regression using mean squared deviation (MSD) or median absolute deviation (MAD) to determine fitting error during the regression, linear least squares or ordinary least squares (OLS), Laplacian KSVM linear regression, fitting using generalized linear models (GLM), hierarchical regression, Bayesian regression; or nonparametric regression, etc.

In some examples, the model selecting module 410 may select a respective model and/or an algorithm for each individual voice data metric. Alternatively, or additionally, the model selecting module 410 may choose the same model and/or algorithm for multiple voice data metrics. Once the one or more machine learning models are selected, the model selecting module 410 may send the selected models to the training module 406.

The training module 406 may be configured to train the selected one or more machine learning models using the training data set to generate one or more filters to determine whether a phone number is a PDN and/or a PHN. In some examples, the training module 406 may implement unsupervised machine learning for the training process. Alternatively, the training module 406 may implement supervised machine learning or semi-supervised machine learning for the training process.

As discussed herein, for each of the plurality of voice data metrics, the training module 406 may train a respective machine learning model and build a filter to predict a category of the incoming call with a probability score in view of the particular voice data metric. In some examples, a first filter may be configured to predict, based on the call durations, a first probability score that the incoming call is classified into PDN/PHN. The short-duration call may indicate the MO caller is likely associated with a PDN/PHN. For instance, when the call duration of a MT call is less than 5 seconds, the first filter may output a probability of 100% that the MT call is a PDN/PHN, while when the call duration is between 5 seconds and 10 seconds, the first filter may output a probability of 90% that the MT call is a PDN/PHN. The first filter may output different probabilities based on different threshold values. In another example, a second filter may be configured to predict, based on the call rejection rates,, a second probability score that the incoming call is classified into PDN/PHN. For instance, when the MT calls originated from the phone number are rejected 90% of the call counts, the second filter may output a probability of 100% that the phone number is a PDN or PHN, while when the rejection rate is 85%, the second filter may output a probability of 90% that the phone number is a PDN or PHN. The higher the rejection rate, the more likely the phone number is a PDN/PHN. Similarly, a third filter may be configured to predict, based on the call no-answering rates, a third probability score that the incoming call is classified into PDN/PHN. When the MT calls originated from the phone number are not answered 95% of the call counts, the third filter may output a probability of 100% that the phone number is a PDN/PHN. In yet another example, a fourth filter may be configured to predict, based on the similarity of the area codes between the MO caller and the MT callee, a fourth probability score that the incoming call is classified into PDN/PHN. For instance, when the phone number has the same area code and exchange code with the MT callee but no caller ID found in the database, the fourth filter may output a probability of 95% that the MO caller is attempting to mimic the friend or family of the MT callee. In some examples, the phone number having the same MCC and MNC code with the MT callee may also indicate a certain probability that the MO caller is mimicking the friend or family of the MT callee.

In some examples, the data from the voice call database 320 may also include personal data periodically backed up to the cloud storage from the user devices. The training module 406 may build one or more additional filters to predict the likelihood that a phone number is associated with PDN/PHN. For example, the training module 406 may build an additional filter based on the calendar data on the MT callee's device. When the calendar data indicates an event is scheduled at the time of the phone call, the additional filter may output a low probability, e.g., 20%, that the phone number is from a PDN/PHN. Alternatively, or additionally, the training module 406 may build an additional filter based on short-call flags on the MT callee's device. If the data on the MT callee's device indicates short-call flags at the time of the phone call, the additional filter may output a low probability that the phone number is from a PDN/PHN. In yet other examples, the PDN/PHN classifier training server 316 may collect feedbacks from the MT callees with respect to a short-duration call, a rejected call, or a no-answering call. The training module 406 may build additional filters based on the feedbacks. For instance, if the feedbacks indicate that the call recipient is unavailable to answer the call, has to reject the call, or cut-short the conversation due to travel, work, or busy with something not on calendar, the additional filter may output a low probability that the call is related to the PDN/PHN.

Base on the probabilities outputted from various filters (e.g., trained machine learning models), the training module 406 may aggregate the predictions by individual filters to determine an overall probability of the phone number being associated with the PDN/PHN. The training module 406 may use an ensemble algorithm to combine the outputs from the various filters such as voting, weighted average voting, bagging, boosting, adaptive boosting, gradient boosting, stacking, blending, etc. The training module 406 may also generate, in addition to the overall probability, information indicative of the classified PDN/PHN patterns. For example, the information may indicate an overall probability 95% of the call recipients did not answer the call. Once the accuracy of the prediction from the training module 406 satisfies a criteria, the training module 406 may generate the PDN/PHN classifier 310 to be implemented in the TAS 116.

By combining the predictions from multiple machine learning models, the overall accuracy of the prediction with respect to whether a phone call is from a potential dislike number or a potential harmful number can be boosted. The TAS 116, therefore, may identify a phone call from a PDN/PHN with more accuracy and can notify the call recipient with specific information about the PDN/PHN using the text strings.

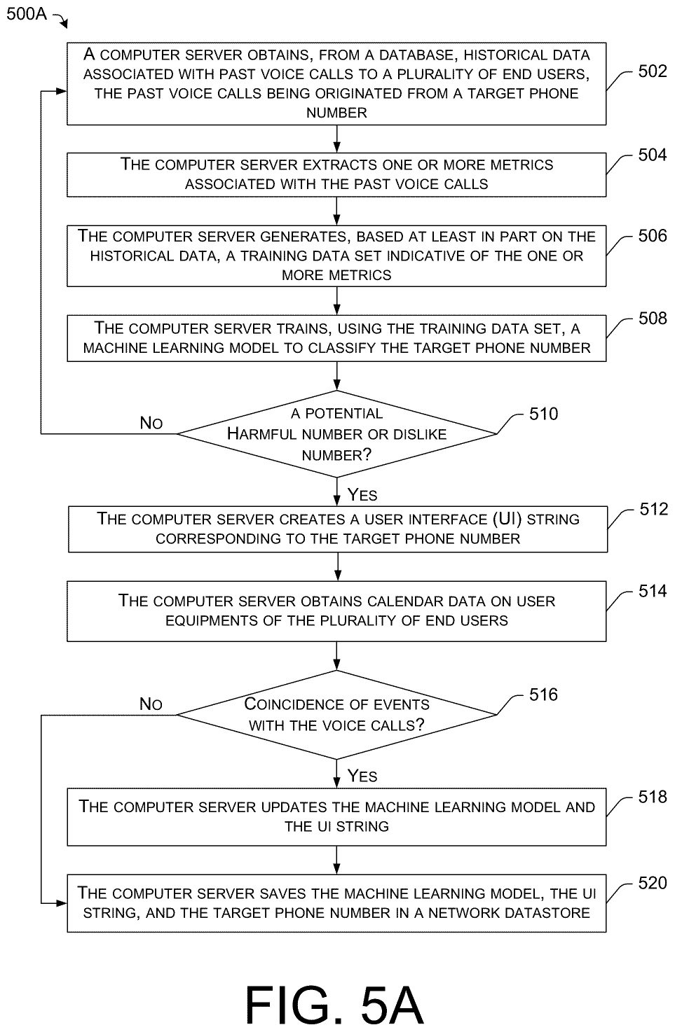

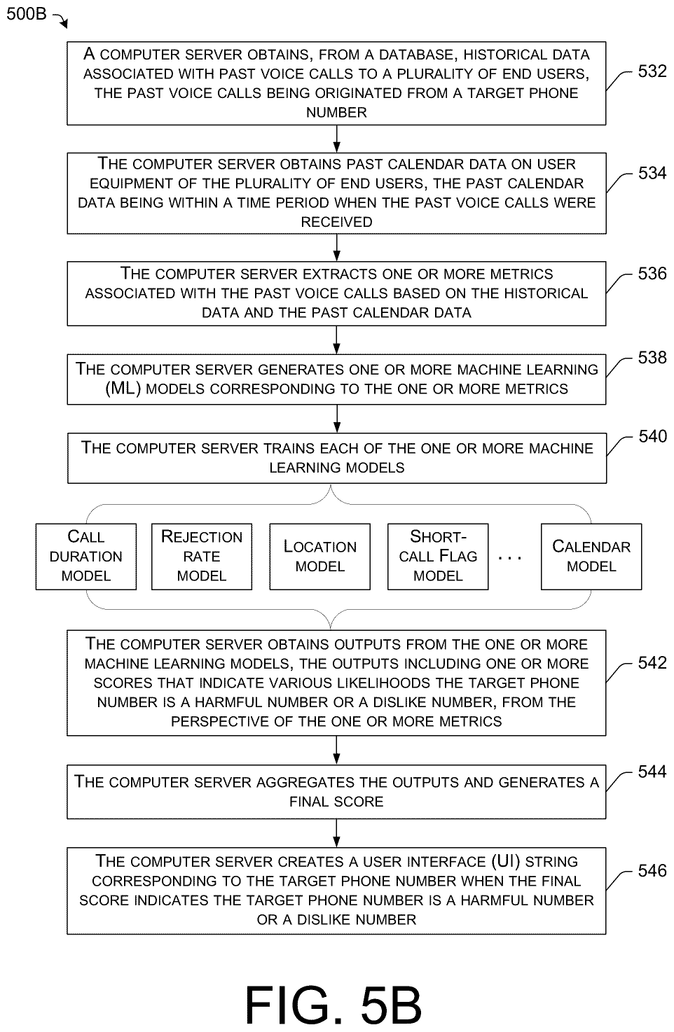

FIG. 5A illustrates an example process for training a classifier for detecting and alerting a voice call from a potential harmful or dislike number, according to an example of the present disclosure. The example process 500A may be implemented by the PDN/PHN classifier training server 316 shown in FIG. 3 and FIG. 4.

At operation 502, a computer server may obtain, from a database, historical data associated with past voice calls to a plurality of end users, the past voice calls being originated from a target phone number. In some examples, the database may be a cloud storage coupled to the telecommunication network. Data stored in the database may include information related to each telephone call such as originating party (e.g., MO caller), terminating party (e.g., MT callee), geographic locations of the MO caller and the MT callee, date and time the call is originated, call duration, whether the call is rejected or not answered, phone number of the MO caller, etc. Additionally, the database may further include data stored on the user devices and periodically backed up to the database such as photos, notes, calendar, tasks, app data, etc.

At operation 504, the computer server may extract one or more metrics associated with the voice calls. As discussed herein, the one or more metrics may be used to determine whether a phone call is potentially from a dislike number or a harmful number. For example, a phone call from a PDN/PHN may have a short call duration, be rejected by the recipient, or not answered at all. In another example, a phone number having the same area code with the recipient's phone number but no caller ID registered may be a PDN/PHN.

At operation 506, the computer server may generate, based at least in part on the historical data, a training data set indicative of the one or more metrics. The computer server may filter the historical data associated with the past voice calls originated from the target phone number (e.g., MT call data) using the one or more metrics and build the training data set.

At operation 508, the computer server may train, using the training data set, a machine learning model to classify the target phone number. In some examples, for each of the one or more metrics, the computer server may generate a machine learning model (e.g., a filter) to predict whether the target phone number is a potential harmful number and/or a potential dislike number. The computer server may use different machine learning model for different metric to predict whether the target phone number is a potential harmful number and/or a potential dislike number. In some examples, the computer server may combine the predictions from various machine learning models to generate an overall prediction with respect to whether the phone number is a potential harmful number and/or a potential dislike number.

At operation 510, the computer server may determine whether the target phone number is a potential harmful number or a dislike number. As discussed herein, if the overall prediction satisfies a threshold, the computer server may determine the target phone number is PDN/PHN. If the target phone number is not a potential harmful number or a dislike number, the operation returns to 502.

If the target phone number is a potential harmful number or a dislike number, at operation 512, the computer server may create a user interface (UI) string corresponding to the target phone number. The UI string may provide the information related to the observed call recipients' behavior. For example, the UI string may provide that “a majority of people did not answer this phone number,” “95% of the phone calls from this phone number were disconnected in 5 seconds,” etc.

At operation 514, the computer server may obtain calendar data on user equipment of the plurality of end user. The calendar data may provide additional information on the end users' schedules. For instance, the end user may not answer an incoming call when he/she is in a meeting, in travel, in a doctor's appointment, etc. In implementations, the calendar data may be obtained from the end user's device upon a user agreement.

At operation 516, the computer server may determine whether there is a coincidence of events with the past voice calls. If there is no coincidence of events with the past voice calls, at operation 520, the computer server may save the machine learning model, the UI string, and the target phone number in a network datastore.

If there is a coincidence of events with the voice calls, the computer server may update the machine learning model and the UI string at operation 518. In some examples, the computer server may generate an additional machine learning model to predict whether the target phone number is PDN/PHN under the circumstance of coincident events. The computer server may further aggregate the predictions from multiple machine learning models to obtain a more accurate prediction on the target phone number. For example, a call-duration based machine learning model may predict that the probability the target phone number being PDN/PHN is 95%. A calendar based machine learning model may predict that the probability the target phone number being PDN/PHN is 10%. The computer server may supplement the additional machine learning model (e.g., the calendar based machine learning model) to the call-duration machine learning model and obtain a more accurate prediction on whether the target phone number is PDN/PHN. For example, the computer server may obtain an overall prediction value as 45%. The computer server may also update the corresponding UI string to indicate the target phone number is less likely to be a PDN/PHN.

At operation 520, the computer server may save the machine learning model, the UI string, and the target phone number in a network datastore. The machine learning model and the UI string may be further downloaded and/or implemented as the PDN/PHN classifier 310 on the TAS 116. The target phone number may be further added to the PDN/PHN blacklist 314 on the TAS 116.

It should be understood that the training of the PDN/PHN classifier 310 may be performed according to a preset schedule such as per week, per month, or every three months, etc. The pattern of the scam like phone calls may vary. Re-training the PDN/PHN classifier 310 may efficiently update the blacklisted PDN/PHN and the content of the strings.

FIG. 5B illustrates another example process for training a classifier for detecting and alerting a voice call from a potential harmful or dislike number, according to an example of the present disclosure. The example process 500B differs from the example process 500A in that the computer server may parallelly generate and train individual machine learning model with respect to each voice call metric.

The computer server may perform operation 532 similarly to operation 502 of FIG. 5A.

At operation 504, the computer server may obtain past calendar data on user equipment of the plurality of end users, the past calendar data being within a time period when the past voice calls were received. In implementations, the past calendar data may be shared by the plurality of end users upon a user agreement.

At operation 536, the computer server may extract one or more metrics associated with the past voice calls based on the historical data and the past calendar data. The one or more metrics may include those described at operation 504 and event data from the past calendar.

At operation 538, the computer server may generate one or more machine learning (ML) models corresponding to the one or more metrics. As discussed herein, the computer server may determine the ML models and/or algorithms that are suitable for the one or more metrics, respectively.

At operation 540, the computer server may train each of the one or more machine learning models, as similar to operations 506 and 508 illustrated in FIG. 5A. The one or more machine learning models may include but are not limited to a call duration model, a rejection rate model, a location model, a short-call flag model, a calendar model, a no-answering rate model, a MCC/MNC model, a user feedback model, etc.

At operation 542, the computer server may obtain outputs from the one or more machine learning models, the outputs including one or more scores that indicate various likelihoods that the target phone number is a harmful number or a dislike number, from the perspective of the one or more metrics. For example, an output from the call duration model may indicate a probability that the target phone number is a PHN/PDN based on the call duration data. An output from the rejection rate model may indicate a probability that the target phone number is a PHN/PDN based on the call rejection rate data.

At operation 544, the computer server may aggregate the outputs and generate a final score. In some examples, the server device may apply any ensemble algorithms to combine the multiple outputs and generate the final score, e.g., an overall prediction as to whether the target phone number should be classified to a PHN/PDN.

At operation 546, the computer server may create a user interface (UI) string corresponding to the target phone number when the final score indicates the target phone number is a harmful number or a dislike number. As discussed herein, the final score may be compared with a preset threshold. The final score meeting or exceeding the preset threshold may indicate the target phone number should be classified as a harmful number or a dislike number.

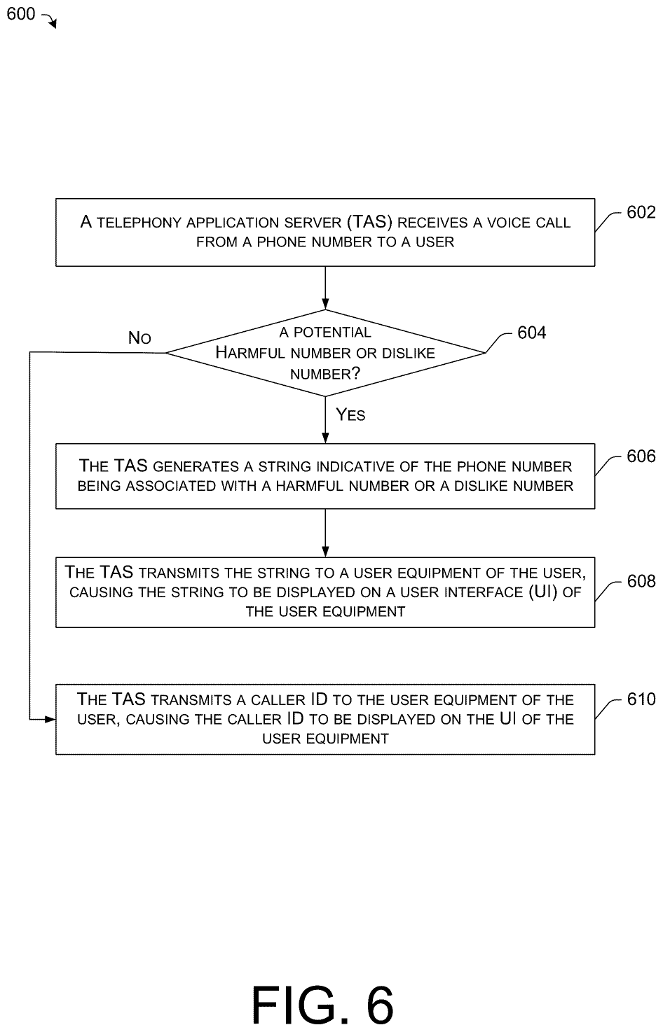

FIG. 6 illustrates an example flowchart for a process 600 for detecting and alerting a voice call from a potential harmful or dislike number, according to an example of the present disclosure. The example process 600 may be implemented by the telephony application server (TAS) 116 shown in FIGS. 1-3.

At operation 602, a telephony application server (TAS) may receive a voice call from a phone number to a user. When a voice call is initiated, a session initiation protocol (SIP) invite message may be transmitted to the IMS network (e.g., IMS network 108 in FIG. 1) through the packet core network (e.g., TAS 116 in FIG. 1). The TAS may maintain a session once the voice call is established.

At operation 604, the TAS may determine whether the phone number is a potential harmful or a potential dislike number. As discussed herein, the TAS may rely on the information from a national caller ID database to determine whether the phone number is registered. If the caller ID of the phone number cannot be found in the national caller ID database, the TAS may look up a PDN/PHN blacklist (e.g., the PDN/PHN blacklist 314) to determine whether the phone number is a potential harmful or a potential dislike number.

If the phone number is a potential harmful or a potential dislike number, at operation 606, the TAS may generate a string indicative of the phone number being associated with a harmful number or a dislike number. As discussed herein, the PDN/PHN blacklist may also indicate a category of the phone number, e.g., a potential harmful number, a potential dislike number, etc. Based on the category of the phone number, the TAS may select one of the strings corresponding to the category. For example, the TAS may select the string of “most calls from the phone number were disconnected in 5 seconds.” In another examples, the TAS may select the string of “90% of the users did not answer this phone number last month.”

At operation 608, the TAS may transmit the string to a user equipment of the user, causing the string to be displayed on a user interface (UI) of the user equipment. As discussed herein, the TAS may display the string along with the phone number on the UI of the user equipment if the phone number is determined to be a PDN/PHN.

If the phone number is not a potential harmful or a potential dislike number, at operation 610, the TAS may transmit a caller ID to the user equipment of the user, causing the caller ID to be displayed on the UI of the user equipment.

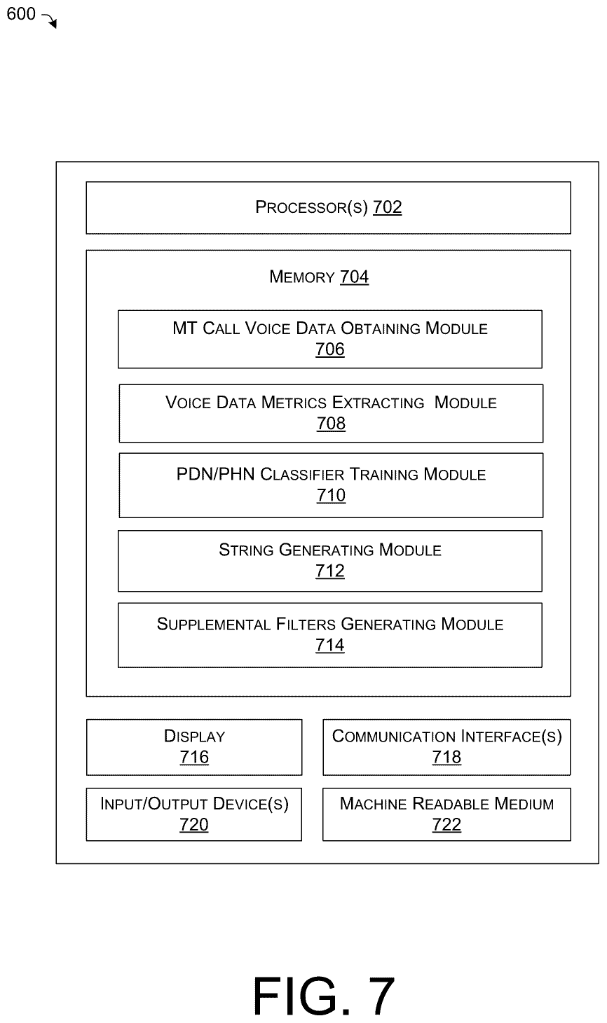

FIG. 7 illustrates an example computer server, in which detection and alert logic by cloud data for a potential harmful or dislike number are implemented, according to an example of the present disclosure. The example computer server 700 may correspond to a telephony application server (TAS) 116, as illustrated in FIGS. 1-3. In some examples, the example computer server 700 may correspond to other computer servers coupled to the telecommunication network.

As illustrated in FIG. 7, a computer server 700 may comprise processor(s) 702, a memory 704 storing an MT voice data obtaining module 706, a voice data metrics extracting module 708, a PDN/PHN classifier training module 710, a string generating module 712, a supplemental filters generating module 714, a display 716, communication interface(s) 718, input/output device(s) 720, and/or a machine readable medium 722.

In various examples, the processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 702 may also be responsible for executing all computer applications stored in memory 704, which can be associated with common types of volatile (RAM) and/or nonvolatile (ROM) memory.

In various examples, the memory 704 can include system memory, which may be volatile (such as RAM), non-volatile (such as ROM, flash memory, etc.) or some combination of the two. The memory 1104 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computer server 700. Any such non-transitory computer-readable media may be part of the computer server 700.

The MT call voice data obtaining module 706 may be configured to obtain the voice data of mobile terminating (MT) calls originated from a same phone number from a database. The voice data metrics extracting module 708 may be configured to extract one or more voice data metrics to determine whether an incoming call is from potentially a harmful number or a dislike number. In some examples, the one or more voice data metrics may include call duration, call rejections rate, call no-answering rate, etc.

Based on the MT call voice data and the one or more voice data metrics, the PDN/PHN classifier training module 710 may train tone or more machine learning models for predicting the probabilities that a phone number is associated with PDN/PHN. The PDN/PHN classifier training module 710 may generate an overall prediction score based on the outputs from the one or more machine learning models. When the prediction accuracy satisfies a threshold, the PDN/PHN classifier training module 710 may generate a PDN/PHN classifier to determine a category of an incoming call, e.g., whether the incoming call is a potential harmful number or a potential dislike number.

The string generating module 712 may be configured to generate one or more strings corresponding to each category. The one or more strings may be text strings that describe the patterns such phone calls. For example, the string may denote that the phone number is mimicking the call recipient's friend or family by having the same area code. In another example, the string may describe an observation that the phone calls originated from the phone number were disconnected in 5 seconds in the past three months.

The supplemental filters generating module 714 may be configured to generate additional filters or machine learning models for additional voice data metrics extracted from data on the user devices. One supplemental filter, for example, may be generated for calendar events to determine whether the incoming call is PDN/PHN when there is a coincidence of events with the incoming call.

The communication interface(s) 718 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 718 can be compatible with multiple radio access technologies, such as 5G radio access technologies and 4G/LTE radio access technologies. Accordingly, the communication interfaces 718 can allow the computer server 700 to connect to the 5G system described herein.

Display 716 can be a liquid crystal display or any other type of display commonly used in the computer server 700. For example, display 716 may be a touch-sensitive display screen and can then also act as an input device or keypad, such as for providing a soft-key keyboard, navigation buttons, or any other type of input. Input/output device(s) 720 can include any sort of output devices known in the art, such as display 716, speakers, a vibrating mechanism, and/or a tactile feedback mechanism. Input/output device(s) 720 can also include ports for one or more peripheral devices, such as headphones, peripheral speakers, and/or a peripheral display. Input/output device(s) 720 can include any sort of input devices known in the art. For example, input/output device(s) 720 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 722 can store one or more sets of instructions, such as software or firmware, that embodies any one or more of the methodologies or functions described herein. The instructions can also reside, completely or at least partially, within the memory 704, processor(s) 702, and/or communication interface(s) 718 during execution thereof by the computer server 700. The memory 704 and the processor(s) 702 also can constitute machine readable media 722.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method comprising:
receiving, at a computer server, a voice call to a user, the voice call being associated with a phone number;
determining, by the computer server, that the phone number is associated with a first category;
generating, by the computer server, a string indicative of the first category; and
presenting, by the computer server, the phone number and the string on a user interface (UI) of a device of the user.

2. The computer-implemented method of claim 1, wherein determining, by the computer server, that the phone number is associated with a first category, further comprises:
applying a machine learning model trained to determine whether the phone number is associated with the first category.

3. The computer-implemented method of claim 2, wherein the first category includes at least one of a potential harmful number or a potential dislike number, and the computer-implemented method further comprises:
training the machine learning model to determine whether a target phone number is at least one of the potential harmful number or the potential dislike number.

4. The computer-implemented method of claim 3, wherein training the machine learning model to determine whether a target phone number is at least one of the potential harmful number or the potential dislike number includes operations of:
obtaining, from a database, data associated with past voice calls to a plurality of end users, the past voice calls being originated from the target phone number;
extracting one or more metrics associated with the past voice calls;
creating, based at least in part on the data, training data set indicative of the one or more metrics;
training, using the training data set, the machine learning model to determine whether the target phone number is at least one of the potential harmful number or the potential dislike number; and
creating a UI string corresponding to the target phone number in response to a determination that the target phone number is at least one of the potential harmful number or the potential dislike number.

5. The computer-implemented method of claim 4, further comprising:
obtaining calendar data on user equipments (UEs) of the plurality of end users;
generating, based at least in part on the calendar data, a first feature indicative of coincidence of events with the past voice calls;
updating, using the training data set and the first feature, the machine learning model to generate an updated machine learning model; and
updating the UI string based on the updated machine learning model.

6. The computer-implemented method of claim 4, further comprising:
obtaining feedbacks on the past voice calls from the plurality of end users;
generating, based at least in part on the feedbacks, a second feature indicative of intentions of handling the past voice calls;
updating, using the training data set and the second feature, the machine learning model to generate an updated machine learning model; and
updating the UI string based on the updated machine learning model.

7. The computer-implemented method of claim 4, wherein the one or more metrics associated with the past voice calls include at least one of:
durations of the past voice calls to the plurality of end users,
rejection rates of the past voice calls to the plurality of end users,
no-answering rates of the past voice calls to the plurality of end users, or
location information of the past voice calls.

8. The computer-implemented method of claim 2, further comprising:
adding, by the computer server, the phone number to blacklist, wherein the blacklist is coupled to a webpage server that facilitates the user to look up the phone number in the blacklist.

9. A system comprising:
a processor,
a network interface, and
a memory storing instructions executed by the processor to perform actions including:
receiving, at a computer server, a voice call to a user, the voice call being associated with a phone number;
determining, by the computer server, that the phone number is associated with a first category:
generating, by the computer server, a string indicative of the first category; and
presenting, by the computer server, the phone number and the string on a user interface (UI) of a device of the user.

10. The system of claim 9, wherein determining, by the computer server, that the phone number is associated with a first category, further comprises:
applying a machine learning model trained to determine whether the phone number is associated with the first category.

11. The system of claim 10, wherein the first category includes at least one of a potential harmful number or a potential dislike number, and the actions further comprise:
training the machine learning model to determine whether a target phone number is at least one of the potential harmful number or the potential dislike number.

12. The system of claim 11, wherein training the machine learning model to determine whether a target phone number is at least one of the potential harmful number or the potential dislike number includes operations of:
obtaining, from a database, data associated with past voice calls to a plurality of end users, the past voice calls being originated from the target phone number;
extracting one or more metrics associated with the past voice calls;
creating, based at least in part on historical data, training data set indicative of the one or more metrics;
training, using the training data set, the machine learning model to determine whether the target phone number is at least one of the potential harmful number or the potential dislike number; and
creating a UI string corresponding to the target phone number in response to a determination that the target phone number is at least one of the potential harmful number or the potential dislike number.

13. The system of claim 12, wherein the operations further comprise:
obtaining calendar data on user equipments (UEs) of the plurality of end users;
generating, based at least in part on the calendar data, a first feature indicative of coincidence of events with the past voice calls;
updating, using the training data set and the first feature, the machine learning model to generate an updated machine learning model; and
updating the UI string based on the updated machine learning model.

14. The system of claim 12, wherein the operations further comprise:
obtaining feedbacks on the past voice calls from the plurality of end users;
generating, based at least in part on the feedbacks, a second feature indicative of intentions of handling past voice calls;
updating, using the training data set and the second feature, the machine learning model to generate an updated machine learning model; and
updating the UI string based on the updated machine learning model.

15. The system of claim 12, wherein the one or more metrics associated with the past voice calls include at least one of:
durations of the past voice calls to the plurality of end users,
rejection rates of the past voice calls to the plurality of end users,
no-answering rates of the past voice calls to the plurality of end users, or
location information of the past voice calls.

16. The system of claim 10, wherein the actions further comprise:
adding, by the computer server, the phone number to a blacklist database, wherein the blacklist database is coupled to a webpage server that facilitates the user to search the phone number in the blacklist database.

17. A computer-readable storage medium storing computer-readable instructions, that when executed by a processor, cause the processor to perform actions comprising:
receiving, at a computer server, a voice call to a user, the voice call being associated with a phone number;
determining, by the computer server, that the phone number is associated with a first category;
generating, by the computer server, a string indicative of the first category; and
presenting, by the computer server, the phone number and the string on a user interface (UI) of a device of the user.

18. The computer-readable storage medium of claim 17, wherein determining, by the computer server, that the phone number is associated with a first category, further comprises:
applying a machine learning model trained to determine whether the phone number is associated with the first category.

19. The computer-readable storage medium of claim 18, wherein the first category includes at least one of a potential harmful number or a potential dislike number, and the actions further comprise:
training the machine learning model to determine whether a target phone number is at least one of the potential harmful number or the potential dislike number.

20. The computer-readable storage medium of claim 19, wherein training the machine learning model to determine whether a target phone number is at least one of the potential harmful number or the potential dislike number includes operations of:
obtaining, from a database, data associated with past voice calls to a plurality of end users, the past voice calls being originated from the target phone number;
extracting one or more metrics associated with the past voice calls;
creating, based at least in part on historical data, training data set indicative of the one or more metrics;
training, using the training data set, the machine learning model to determine whether the target phone number is at least one of the potential harmful number or the potential dislike number; and
creating a UI string corresponding to the target phone number in response to a determination that the target phone number is at least one of the potential harmful number or the potential dislike number.
